(19) United States
(12) Patent Application Publication
(10) Pub. No.: US 2005/0206841 A1
(43) Pub. Date: Sep. 22, 2005

(54) Goggle lens

(76) Inventors: Davin Saderholm, Lake Forest, CA (US); Robert Radi, Beverly Hills, CA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/086,537

(22) Filed: Mar. 22, 2005

Related U.S. Application Data
(60) Provisional application No. 60/555,610, filed on Mar. 22, 2004.
(60) Provisional application No. 60/632,597, filed on Dec. 1, 2004.

(51) Int. Cl. G02C 7/06; G02C 7/02

(52) U.S. Cl. 351/159

(57) ABSTRACT

A goggle/face mask lens includes an optically corrected first region and peripheral second region.

### RELATED APPLICATIONS AND CLAIM OF PRIORITY

This application claims priority to, and incorporates by reference, U.S. Provisional Patent Application No. 60/555,610, filed Mar. 22, 2004, and U.S. Provisional Patent Application No. 60/632,597, filed Dec. 1, 2004.

### TECHNICAL FIELD

The description contained herein generally relates to goggles and face mask lenses. More particularly, the description contained herein relates to wide periphery goggle/face mask designs and lens geometries.

### BACKGROUND

Wide periphery goggle and face masks have multiple applications, including skiing, military use, motocross, underwater diving masks, and a variety of industrial safety applications such as welding and for power operators. Typically, wide periphery goggle/face mask lenses are comprised of a lens section that curves around a wearer's face to provide the wearer with enhanced peripheral vision while not substantially increasing the overall width of the lens. Such lenses generally include either cylindrical lenses or polaric ellipsoid (toric) lenses with optical adjustments made to the inner and outer surfaces of the lens to correct for optical refraction and lens position with respect to the wearer's eyes.

Cylindrical lenses have at least one portion formed like part of a cylinder. Cylindrical lenses may be used in a plano-convex configuration to provide a positive focal length that expands an image and focuses light, or they may have a plano-concave configuration to reduce an image or spread light through negative correction.

A toric ellipsoid lens has an aspherical shape corresponding to the rotation of an arc about an axis at right angles to its elongation. In both cylindrical and polaric ellipsoid (toric) lens shapes available in the prior art, the field of view for the wearer is limited, especially in the peripheral vision area, due to the overall size of the lens required in order to add significantly to the peripheral vision area. This creates a “tunnel vision effect” due to the mismatch of the geometry of the lens with respect to the human head. This makes it difficult for the wearer to have clear peripheral vision, and also it does not allow for good “cross viewing” so that the wearer can use the goggle/face mask while looking at an angle through an aiming scope or aiming sight.

Moreover, in both cylindrical and toric lenses, in order to improve the peripheral vision of the wearer, an increase in the overall size of the goggle/face mask is required. This overall size increase makes the goggle/face mask overly cumbersome to wear and impractical when combined with the constraints of other on-body gear and equipment, such as helmets, headphone audio systems, and “drop down” night vision systems used in military applications.

Another problem with conventional wide periphery goggle/face mask lenses is that the current geometry of cylindrical and toric lenses does not allow for an enhanced viewing area, particularly one that allows for prescription eyewear to fit comfortably under the goggle/face mask, without significantly increasing both the lateral size and profile dimensions of the goggle/face mask.

In view of the foregoing, there is a need for a goggle/face mask lens geometry that both enhances the peripheral viewing area of the wearer while maintaining optical clarity in the primary viewing area.

### SUMMARY

In an embodiment, a lens includes a first region and a second region that are interconnected. The first region contains a primary viewing area located at least in part in front of the wearer's eyes and includes an optically corrected lens, and the second region contains a peripheral vision area located in an area that is not required for primary viewing. Optionally, the first region may have a cylindrical lens section that counters prismatic refraction that occurs when light passes through the cylindrical lens section. In some embodiments, the first region may include upper and lower sections with dissimilar optical correction geometries applied to each section. The second region may include at least one section on each lateral side of the lens that wraps away from the first region at a smaller radius of curvature than a radius of curvature of the first region. The second region may or may not be optically corrected. Optionally, there may also be a third and fourth region that form a shield, where the third region extends from a top portion of the primary region and the fourth region extends from a bottom portion of the primary region. The lens may also include a frame where at least a portion of the frame is made of a lens-grade material, and the second region of the lens may optionally include at least a portion of the frame. The first and second region of the lens may be comprised of the same material where there are no seams between them. The lens may also include an intermediate region where the first region overlaps with the second region, and where the intermediate region includes a lens having optical correction that is different from that of the first region. In some embodiments, the distance from the pupil of the wearer to the first region is between about 0.86 inches and about 1.06 inches. In some embodiments, the overall width of the distance from the outside edge of one eye of the wearer to the outside edge of the other eye of the wearer is between about 9.0 inches and about 9.5 inches.

In another embodiment, a lens includes an optically corrected first region and a second region that are interconnected, where the second region is located in an area that, when the lens is worn by a person, is located within the person's area of peripheral vision. The second region may or may not be optically corrected. In some embodiments, the first region may include upper and lower sections with dissimilar optical correction geometries applied to each. The lens may also include an intermediate region where the first region overlaps with the second region, and where the intermediate region includes a lens having optical correction that is different from that of the first region. In some embodiments, the distance from the pupil of the wearer to the first region is between about 0.86 inches and about 1.06 inches. In some embodiments, the overall width of the distance from the outside edge of one eye of the wearer to the outside edge of the other eye of the wearer is between about 9.0 inches and about 9.5 inches.

### BRIEF DESCRIPTION OF THE DRAWINGS

FIG. 1 is a perspective view of an embodiment of a lens.

FIG. 2 is a top view of an embodiment of a goggle lens.

FIG. 3 is a front view of an embodiment of a goggle lens.

FIG. 4 is a reverse perspective view of an embodiment of a goggle lens.

FIG. 5 is a top view of an alternate embodiment of a goggle lens.

FIG. 6 is a side view of an alternate embodiment of a goggle lens.

FIG. 7 is a top view depicting dimensions of an embodiment of a goggle lens.

FIG. 8 is a front view of an embodiment of a goggle lens.

FIG. 9 is a peripheral view of an embodiment of a goggle lens.

### DETAILED DESCRIPTION

Before the present devices and methods are described, it is to be understood that this invention is not limited to the particular processes, devices or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural references unless the context clearly dictates otherwise.

Unless defined otherwise, all technical and scientific terms used herein have the same meanings as commonly understood by one of ordinary skill in the art. For example, a reference to a “goggle” may include any goggle, face mask or other device having a transparent or otherwise see-through shield. Any methods and materials similar or equivalent to those described herein may be used in the practice or testing of embodiments described herein. All publications mentioned herein are incorporated by reference in their entirety. Nothing herein is to be construed as an admission that the invention is not entitled to antedate such disclosure by virtue of prior invention.

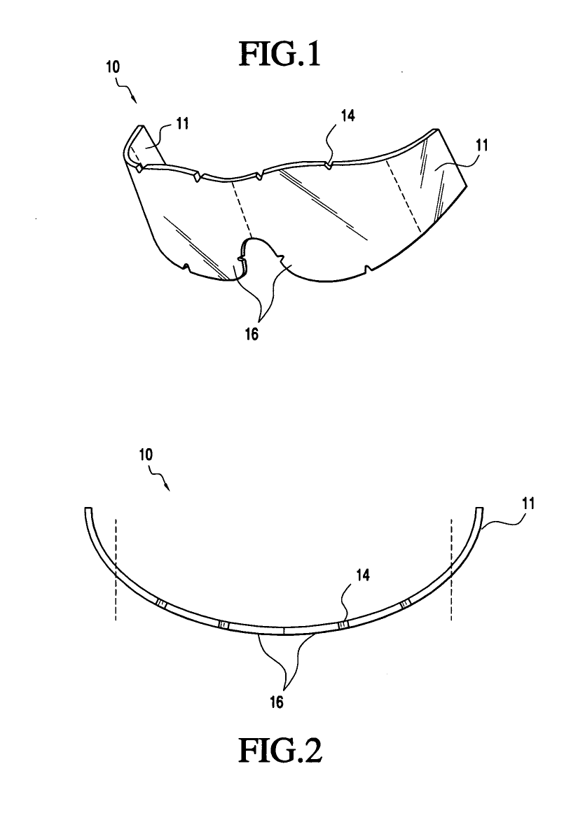

Referring to FIGS. 1 to 4, there is illustrated a goggle/face mask lens constructed in accordance with one embodiment. The goggle/face mask lens includes a shield-like lens with at least two regions that are interconnected. By the term “interconnected,” it is meant that the regions may be integral so that one monolithic lens forms two or more regions, or that the regions may be separate pieces with a seam in the middle. The first region 16 may include an optically corrected, predominantly cylindrical, lens section referred to as the “primary viewing area.” This primary viewing area 16 may be located predominantly in the area that is in front of the wearer's eyes. The second region 11 includes a non-optically corrected or negatively corrected, particularly slightly negatively corrected, lens area referred to as the “peripheral vision area(s).” Each peripheral vision area 11 may generally start near the edge of the wearer's eye, and optionally in front of the viewer's face between the eye and the ear, where the primary viewing area ends, and it includes areas of the lens that are not required for primary viewing. The peripheral vision areas 11 may continue from the primary viewing area 16 around the wearer's head (not shown in the attached Figures). There is no limit as to the complete “wrap” length of the peripheral vision areas 11, and the peripheral areas may wrap as far behind the wearer's head as desired, or they may end at any distance along the way as shown in the Figures. When the goggle/face mask is worn, the primary vision area 16 may at least extend directly across the wearer's normal straight ahead line of sight from each eye, and each peripheral vision area 11 should at least extend across the wearer's peripheral zones of vision. The dashed lines in FIGS. 1-4 show optional seams between or within the relevant sections.

Optionally, as shown in FIG. 5, the lens 10 may include one or more additional edge areas 12 that are in directions that are located upward and/or downward, optionally in a shield-like manner, from the primary viewing area 16. The edge areas 12 may be distinct, as shown in FIG. 5, or they may form a monolithic edge at the top and/or bottom of the primary viewing area 16. The edge areas 12 may be parallel to the primary viewing area 16, or they may be positioned at an angle from the primary viewing area 16 as show in FIG. 5.

The primary viewing area 16 of one embodiment includes an essentially dual cylindrical cross section with an inner and outer cylinder geometry designed to create an optically corrected section. Optical correction is optional, however, and there may be no correction necessary depending on the relative curvature or flatness of the lens. The optically corrected section has the effect of countering some or all of the prismatic refraction that occurs when light passes through a cylindrical lens section. For example, in an embodiment the primary viewing area 16 may provide negative correction by having a plano-concave configuration, such that the center of the lens (i.e., the portion directly in front of the wearer's pupil) is thinner than portions above and below the pupil. However, other configurations, such as plano-convex, bi-convex, bi-concave, toric, or meniscus configurations are possible. The optical correction may help to prevent the wearer from experiencing undue eyestrain or other optical discomfort as a result of looking through the lens for extended durations. The precise geometry of the optically corrected section may be adjusted to the individual needs of the wearer, and the wearer's own prescription eyewear may be considered when determining the exact geometry of the optically corrected section. Optionally, the primary viewing area may have different optical correction characteristics in an upper portion as compared to a lower portion.

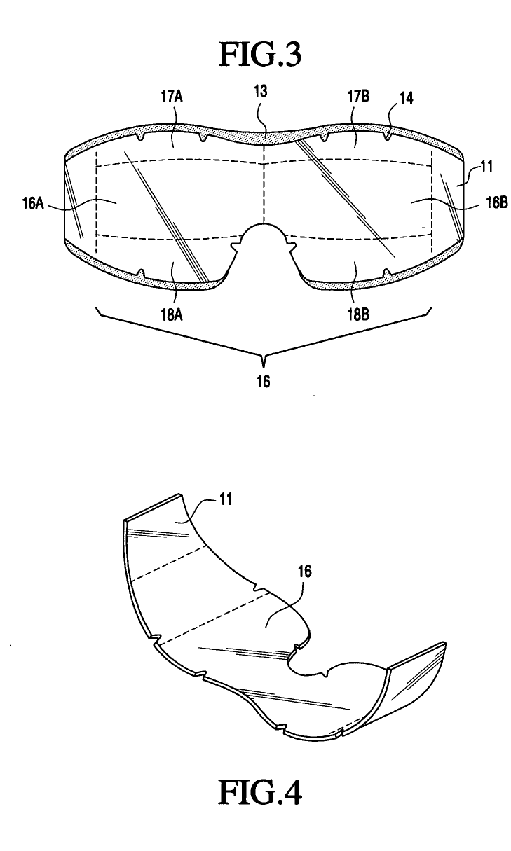

In an alternate embodiment shown in FIG. 3, the primary viewing area 16 may also comprise at least two zones of optically corrected lens geometry. The first zone 16A may comprise any optically corrected, such as a dual cylindrical, cross section for the correction of some or all prismatic refraction in front of one eye, and the second zone 16B may include a similar section for the other eye. Optionally, customized prescription lens inserts may be installed in each of sections 16A and 16B. The primary viewing area 16 may also optionally include upper 17A, 17B and lower 18A, 18B sections with different optical correction, or no optical correction compared to the corrected sections 16A and 16B. Optionally, sections 18A and 18B could extend below the wearer's nose to provide a shield.

The peripheral vision areas 11 comprise areas of the lens not required for primary viewing, and they may help to provide the wearer with a heightened sense of space and peripheral visibility. In an embodiment, the peripheral vision areas 11 comprise at least two sections, as shown in FIGS. 1-4 (one on each lateral side of the lens) that wrap back and away from the essentially cylindrical cross section of the primary viewing area 16. The peripheral sections 11 wrap backward, or away from the center of the primary viewing area 16, at a radius of curvature that is smaller than the radius of curvature of the essentially cylindrical section of the primary viewing area. This may allow for enhanced peripheral vision without requiring the peripheral vision area to continue the essentially cylindrical section, thus it may help prevent the lens from being bulky and so far away from the face that the goggle/face mask would be uncomfortable to the wearer.

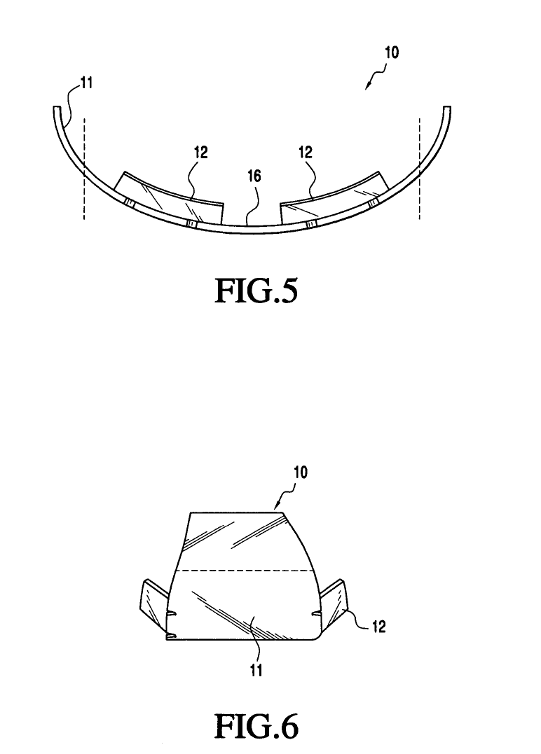

In an embodiment illustrated in FIGS. 5-6, the peripheral vision area may also include two or more sections 12 that are located under and/or over the primary viewing area, optionally in a shield-like configuration. Such sections 12 may wrap away from the primary viewing area directly at an obtuse, acute, or right angle, and at various curvatures including, but not limited to, radiused curvatures. In an alternate embodiment, the sections 12 may be substantially parallel to primary viewing area 16.

In an embodiment, the peripheral vision areas 11 may be corrected, such as with a slight negative correction, to improve vision when the wearer looks cross-wise. Thus, when the wearer's eyes are angled to the side, the slight negative power may minimize optical distortion that might otherwise occur at the transition between the primary viewing area and the peripheral vision area. In other words, in one embodiment when a wearer looks to the side, the eye closest to the relevant peripheral viewing area 11 may use the negative correction to balance with the eye farthest away that is looking through a slightly positively corrected, or non-corrected (depending on the flatness of the lens), section of the primary viewing area lens. In one embodiment, the size of the peripheral vision areas 11 may be lengthened without altering the size of the primary viewing area. This allows for the incorporation of one basic lens geometry to produce multiple goggle/face mask designs with the same primary viewing area.

The lens regions of the goggle/face mask may be designed geometrically in a manner that accommodates the various design parameters of the corresponding headgear, such as a ventilation system 13 for fog prevention and dust prevention for inclusion in the edge areas as shown in FIG. 3. Further, the lens 10 may include indents 14 or other features to accept a frame as shown in FIG. 3. The location, number, and shape of indents shown in the accompanying figures reflect examples, and any location, number or shape may be used depending on the size and shape of the frame. Optionally, there may be no frame at all, whereby indents may be unnecessary. Also optionally, a frame may include a groove that accepts the lens, also rendering indents 14 unnecessary. The frame may be in the form of a goggle, helmet or other headgear. The frame is in fact optional, as the goggle may include peripheral sections that are designed to rest on a wearer's ears. The thickness of the lens areas may vary depending on the needs of the individual wearer.

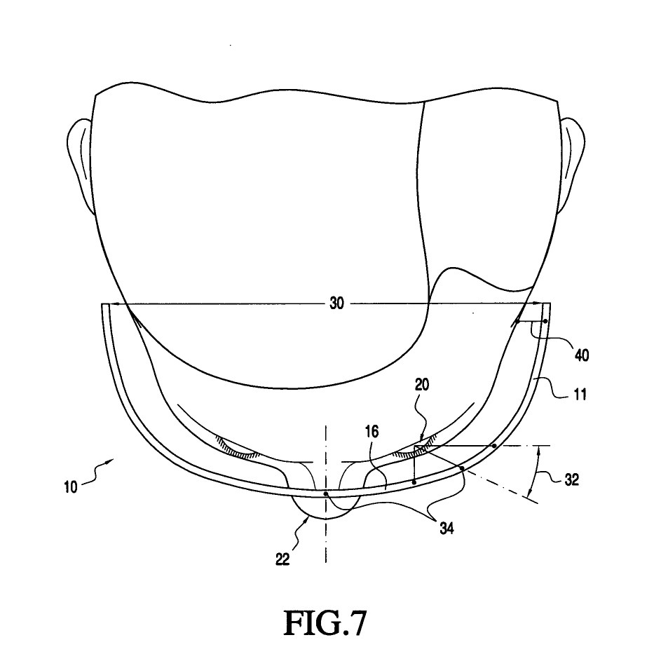

The primary viewing area 16 and the peripheral vision areas 11 may be interconnected at a point in the lens geometry where the primary viewing area 16 makes a transition into the peripheral vision area 11 which may be optically corrected. As shown in FIG. 7, in an embodiment this generally occurs at a distance 34 of from about 2 inches to about 2.75 inches from the center of the primary viewing area 16, or the center of the wearer's nose 22, for an adult lens. From the wearer's perspective, in an embodiment the peripheral vision area may generally begin when the wearer's eye 20 closest to the peripheral vision area 11 is angled 32 about twenty degrees from a line that is perpendicular to the wearer's direct front vision. Optionally, there may be an “intermediate area” that occurs where the primary viewing area 16 overlaps with the corrected peripheral vision area. In an embodiment, the overall width 30 of the lens 10 may be from about 9 inches to about 9.5 inches. This may provide an improved peripheral vision as compared to typical goggle/face mask lenses that generally have a width of about 7.5 inches.

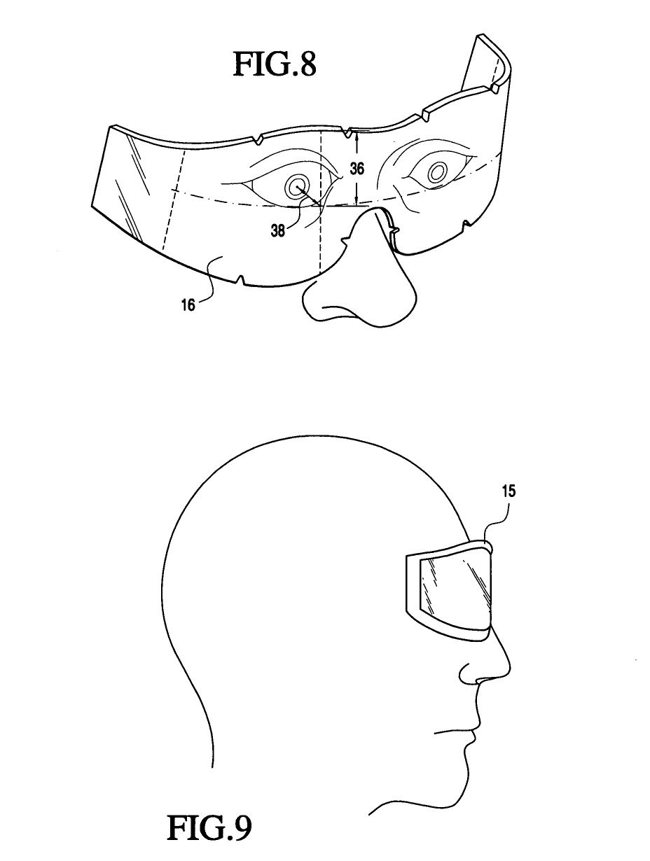

In an embodiment depicted in FIGS. 7 and 8, the primary viewing area 16 of the lens is relatively flat (i.e., only slightly curved) and of a size that allows for a comfortable fit over prescription eyewear. In an embodiment, the profile distance 38 from the wearer's pupil to the primary viewing area 16 (i.e., how much the goggle/face mask extends away from the face) is from about 0.86 inches to about 1.06 inches, ideally at a distance of about 0.965 inches. In an embodiment, the distance 40 from the wearer's face to the top of the peripheral vision area is from about 0.4 inches to about 0.6 inches. This embodiment comprises a lens profile that may allow room for the use of a “drop down” night vision system typically used in military applications. In order to allow for a ventilation system and/or a helmet to be worn along with the goggles/face mask, in an embodiment the distance 36 from the center of the wearer's pupil to the top edge of the lens may be about 1.734 inches, but it may be shorter or longer depending on the needs of the wearer. The bottom part of the lens (i.e. the distance from the center of the wearer's pupil to the bottom edge of the lens) has no limit, and may extend as far downward over the face as desired.

In an embodiment shown in FIG. 9, the lens of the goggle/face mask may be contained in a mounting frame 15 configured to support the lens on the wearer's head in the as-worn orientation. The frame may comprise any of a variety of metals, composites or relatively rigid, molded thermoplastic materials or other materials that are well-known in the art, and it may be transparent or it may have any of a variety of colors. In one embodiment, at least a portion of the frame may be constructed of lens-grade material that is soft and pliable enough to allow for a good fit to the wearer's face or head. In an embodiment, the frame may be constructed of a relatively flexible yet elastic material, which can deform to facilitate application to the wearer's head and return to the molded shape to retain the lenses in the desired orientation. Unlike typical goggle/face mask assemblies where the lens is contained in a frame that is opaque or only slightly translucent, the peripheral vision area of this embodiment may include portions of the goggle/face mask frame itself, thus providing the wearer with a more heightened sense of space and peripheral visibility. The lens may include notches, or indents, that accept a frame as well as a ventilation system used for fog prevention.

The goggle/face mask may be formed of any of a variety of lens-grade materials, such as crown glass, flint glass composites or relatively rigid, molded thermoplastic materials which are well known in the art, including but not limited to acrylics, amorphous polyolefin, polycarbonate, fused silica, and/or polystyrene, and it may be clear transparent, tinted or any variety of colors. Optionally, the lens may be formed of a shatterproof or shatter-resistant material. Optionally, some or all of the lens may be coated with an antireflective coating and/or scratch-resistant coating known to those skilled in the art. Such coatings may be applied using any process known in the art, such as physical vapor deposition, sputtering or other methods.

In one embodiment, the primary viewing area and the peripheral vision areas are constructed of the same lens material, and there are no seams between the primary viewing area and the peripheral vision areas. This is not a requirement, however, and the primary and peripheral areas may also be constructed of different lens materials. The goggle/face mask lens may be manufactured through any process known in the art, such as injection molding. After molding, it can be machined for optical correction using any standard lens creation procedure that is well known in the art.

While various embodiments have been described, those skilled in the art will understand that various changes may be made and equivalents may be substituted for elements thereof without departing from the scope of the invention. In addition, many modifications may be made to adapt a particular situation or material to the teachings herein without departing from the essential scope thereof. Therefore, it is intended that the invention not be limited to the particular embodiment disclosed as the best mode contemplated for carrying out this invention, but that the disclosure will include all embodiments falling within the scope of the appended claims.

1. A lens comprising:
a first region and a second region;
wherein the first region comprises a primary viewing area located at least in part in front of the wearer's eyes; and
the second region comprises a peripheral vision area located in an area not required for primary viewing;
wherein the first and second regions are interconnected; and
wherein the first region comprises an optically corrected lens.

2. The lens of claim 1, wherein the first region comprises a cylindrical lens section that counters prismatic refraction that occurs when light passes through the cylindrical lens section.

3. The lens of claim 1, wherein the first region comprises upper and lower sections with dissimilar optical correction geometries applied to each section.

4. The lens of claim 1:
wherein the second region comprises at least one section on each lateral side of the lens; and
wherein each section wraps away from the first region at a smaller radius of curvature than a radius of curvature of the first region.

5. The lens of claim 1, wherein the second region is non-optically corrected.

6. The lens of claim 1, wherein the second region is optically corrected.

7. The lens of claim 1, further comprising:
a third region that extends from a top portion of the primary region;
a fourth region that extends from a bottom portion of the primary region; and
wherein the third and fourth regions form a shield.

8. The lens of claim 1, further comprising a frame, wherein at least a portion of the frame is comprised of a lens-grade material.

9. The lens of claim 8, wherein the second region comprises at least a portion of the frame.

10. The lens of claim 1, wherein the first region and the second region are comprised of the same material and there are no seams between the first region and second region.

11. The lens of claim 1:
wherein the first region overlaps with the second region in an intermediate region; and
wherein the intermediate region includes a lens having optical correction that is different from that of the first region.

12. The lens of claim 1, wherein the distance from the pupil of the wearer to the first region is from about 0.86 inches to about 1.06 inches.

13. The lens of claim 1, wherein the overall width of the distance from the outside edge of one eye of the wearer to the outside edge of the other eye of the wearer is from about 9.0 inches to about 9.5 inches.

14. A lens comprising:
an optically corrected first region;
a second region located in an area that, when worn by a person, is located within the person's area of peripheral vision;
wherein the first and second regions are interconnected.

15. The lens of claim 14, wherein the second region is non-optically corrected.

16. The lens of claim 14, wherein the second region is optically corrected.

17. The lens of claim 14, wherein the first region comprises upper and lower sections with dissimilar optical correction geometries applied to each section.

18. The lens of claim 14:
wherein the first region overlaps with the second region in an intermediate region; and
wherein the intermediate region includes a lens having optical correction that is different from that of the first region.

19. The lens of claim 14, wherein the distance from the pupil of the wearer to the first region is from about 0.86 inches to about 1.06 inches.

20. The lens of claim 14, wherein the overall width of the distance from the outside edge of one eye of the wearer to the outside edge of the other eye of the wearer is from about 9.0 inches to about 9.5 inches.
